(19) United States
(12) Patent Application Publication
(10) Pub. No.: US 2012/0234768 A1
(43) Pub. Date: Sep. 20, 2012

(54) RESIN COMPOSITE, FILTER AID FOR WATER TREATMENT, PRECOAT MATERIAL FOR WATER TREATMENT, AND WATER TREATMENT METHOD

(75) Inventors: Taro Fukaya, Tokyo (JP); Kenji Tsutsumi, Yokohama-shi (JP); Atsushi Yamazaki, Tokyo (JP); Ichiro Yamanashi, Tokyo (JP); Hirofumi Noguchi, Sakai-shi (JP); Yasutaka Kikuchi, Tokyo (JP); Shuji Seki, Yokohama-shi (JP)

(73) Assignee: KABUSHIKI KAISHA TOSHIBA, Tokyo (JP)

(21) Appl. No.: 13/194,115

(22) Filed: Jul. 29, 2011

(30) Foreign Application Priority Data
Mar. 15, 2011 (JP) 2011-057131

(51) Int. Cl. B01D 35/06; H01F 1/113; C08L 83/06; C08L 33/12; C08L 25/06; C02F 1/48; C08L 33/20

(52) U.S. Cl. 210/695; 210/506; 252/62.54

(57) ABSTRACT

According to one embodiment, a magnetic material coated resin includes an aggregate obtainable by aggregation of primary particles includes magnetic particles of which surfaces are coated with a polymer. The primary particles have an average diameter D1 which is 0.5 to 20 μm. The aggregate has an average aggregate diameter D2 which satisfies D1<D2≦20 μm. The polymer has an average surface coating thickness t which satisfies 0.01<t≦0.25 μm.

### CROSS-REFERENCE TO RELATED APPLICATIONS

This application is based upon and claims the benefit of priority from prior Japanese Patent Application No. 2011-057131, filed Mar. 15, 2011, the entire contents of which are incorporated herein by reference.

### FIELD

Embodiments described herein relate generally to a resin composite (resin-coated magnetic material) containing a magnetic powder and a polymer, a filter aid for water treatment to be used for separating and removing a harmful substance and a valuable substance contained in water, a precoat material for water treatment, and a water treatment method using them.

### BACKGROUND

Recently, there has been a demand for effective use of water resource in view of industrial development and popularity increase. For the effective use, it is considerably important to reuse wastewater such as industrial effluent. In order to attain the reuse, it is necessary to purify the water, or, to separate certain substances from the water. Various methods have been known as methods for separating substances from a liquid, and examples thereof include membrane separation, centrifugal separation, activated carbon adsorption, ozone treatment, elimination of suspended substance by coagulation, and the like. It is possible to remove chemical substances which are contained in the water and can exert large influence on environment, such as phosphor and nitrogen, as well as to remove oils, clay, and the like dispersed into the water.

Among the various water treatment methods, the membrane separation method is one of the methods which are most ordinarily employed for eliminating insoluble substances in water, and a filter aid is used for the membrane separation method from the viewpoints of membrane protection and an increase in passing rate of water containing hardly dewaterable substances.

Meanwhile, as a method for eliminating a harmful substance and a valuable substance, there has been known a solid separation method of precipitating a substance dissolved in water by allowing a predetermined reaction of the substance. In one of the conventional methods, a hardly filterable substance such as seaweed is eliminated by adding a powder of a paramagnetic substance to wastewater. Further, in another conventional method, fluorine in water is eliminated by changing fluorine into calcium fluoride. In yet another conventional method, fluorine in water is precipitated and eliminated by using an aggregating polymer.

However, in the conventional method, in order to readily eliminate calcium fluoride obtained by a reaction with calcium carbonate, a part of crystals of the obtained calcium fluoride is returned to a reaction tank and recrystallized. Therefore, there has been a problem of a decrease in effluent treatment efficiency. Further, though a particle diameter is increased by using the aggregating polymer in the conventional methods, there have been problems of a decrease in purity of a recovered substance and an increase in amount of sludge in the case of disposition. The number of steps can be reduced by solid separation of the substances by direct filtering or the like, but it is difficult to perform the direct filtering due to the small particle diameter. It is still difficult to efficiently eliminate the particles from the water by employing the conventional methods.

### BRIEF DESCRIPTION OF THE DRAWINGS

FIG. 1 is a constitution block diagram showing an apparatus used for a water treatment method according to a first embodiment;

FIG. 2 is a diagram showing steps of the water treatment method (precoat method) according to the first embodiment using the apparatus of FIG. 1;

FIG. 3A is a sectional view showing an aggregate of magnetic material particles, and FIG. 3B is a sectional view showing the magnetic material particles coated with a polymer;

FIG. 4 is a constitution block diagram showing an apparatus used for a water treatment method according to a second embodiment; and

FIG. 5 is a diagram showing steps of the water treatment method (body feed method) according to the second embodiment using the apparatus of FIG. 2.

### DETAILED DESCRIPTION

Various embodiments will be described hereinafter with reference to the accompanying drawing.

(1) A resin composite of the embodiments, comprises aggregates of primary particles each comprising a magnetic particle of which surface is coated with a polymer, wherein the primary particles have an average diameter D1 which is 0.5 to 20 μm; the aggregates have an average aggregate diameter D2 which satisfies D1<D22≦20 μm; and the polymer has an average surface coating thickness t which satisfies 0.01<t≦0.25 μm.

A resin composite (resin-coated magnetic material) of embodiments described herein has considerably excellent durability and, therefore, is recoverable and reusable repetitively.

According to the embodiments described herein, an average diameter D1 of primary particles is within a range of 0.5 to 20 μm, more preferably within a range of 0.5 to 15 μm. When the average diameter D1 of the primary particles is less than 0.5 μm, a distance between the particles becomes too small due to too dense aggregation of the particles, thereby making it difficult to attain an effective water passing rate. On the other hand, when the average diameter D1 of the primary particles exceeds 20 μm, the particles are aggregated coarsely to increase the distance between the particles and to allow fine particles in water (valuable substance or harmful substance) to readily pass through, resulting in large reduction in fine particle recovery efficiency. Further, when the average diameter D1 of the primary particles is less than 15 μm, a recovery efficiency of fine particles (precipitated metallic compound grains) is further improved. By the way, the inventors found that it is impossible to attain the effective fine particle recovery efficiency in the case where the average diameter D1 of the primary particles is 26 μm, for example, as a result of a verification test. From such result, it is understood that the fine particle recovery efficiency is deteriorated when the average diameter D1 of the primary particles is excessively large.

According to the embodiments described herein, an average aggregate diameter D2 of an aggregate of the primary particles is so set as to satisfy D1<D2≦20 μm, more preferably D1<D21≦15 μm. When the average aggregate diameter D2 of the aggregate exceeds 20 μm, the fine particles in water are allowed to readily pass through as described above, resulting in reduction in fine particle recovery efficiency. Further, when the average aggregate diameter D2 is 15 μm, the fine particle recovery rate is further improved as described above.

According to the embodiments described herein, an average coating thickness t of a polymer satisfies 0.01≦t≦0.25 μm, more preferably 0.01≦t≦0.15 μm. When the average coating thickness t of the polymer is less than 0.01 μm, strength of a secondary aggregate is reduced to make it impossible to withstand use in water, and a desired coating effect is not attained. In contrast, when the coating thickness t exceeds 0.25 μm, the average diameter D1 of the primary particles and the average aggregate diameter D2 of the aggregate are increased to result in reduction in clearance between the particles, thereby making it impossible to ensure the effective water passing rate when used as a filter aid. Further, when the coating thickness t is 0.15 μm or less, a capturing property of capturing fine particles is enhanced to further improve the fine grain recovery efficiency. A coating amount of the polymer may be calculated by observation using an optical microscope or a SEM, but it is preferable to accurately detect the polymer coating amount by: heating a resin composite in an oxygen-free state to cause heat decomposition; detecting a weight reduction, i.e., the polymer coating amount; and calculating an average thickness of a polymer layer from specific surfaces of the particles.

(2) In the resin composite according to (1) described above, each of the magnetic particles may preferably be made of magnetite. Magnetite (Fe₃O₄) is suitably used as a material for water treatment since magnetite is not only inexpensive but also safety as an element due to its stable function as a magnetic material in water.

(3) In the resin composite according to (1) described above, the polymer is one or more selected from the group consisting of polyacrylonitrile, polymethylmethacrylate, polystyrene, and copolymers thereof.

It is possible to select the suitable one as the polymer depending on the objective, but it is particularly preferable to use polyacrylonitrile, polymethylmethacrylate, polystyrene, or a copolymer thereof since it is easy to coat a magnetic powder of magnetite or the like with the polymer, and since the polymer has acid resistance and alkali resistance.

(4) In the resin composite according to (1) described above, the polymer may preferably be phenolic resin. Because phenolic resin is excellent in dispersion into water.

(5) In the resin composite according to (1) described above, the polymer may preferably be a condensate of trialkoxysilane since the trialkoxysilane condensate has high safety in water due to its capability of being firmly adhering to the magnetic powder.

(6) A filter aid for water treatment of the embodiments comprises aggregates of primary particles each comprising a magnetic particle of which surface is coated with a polymer, in which the primary particles have an average diameter D1 which is 0.5 to 20 μm, the aggregates have an average aggregate diameter D2 which satisfies D1<D2≦20 μm, and the polymer has an average surface coating thickness t which satisfies 0.01<t≦0.25 μm,

wherein, (a) in a case where the filter aid forms a precoat layer on a filter,

the filter aid is mixed with a dispersion medium to provide a suspension of the filter aid in the dispersion medium, and the suspension is filtered through the filter, thereby forming the precoat layer of the filter aid on the filter,

water to be treated containing a metallic ion is alkalified to precipitate metallic compound grains in the water to be treated,

the water to be treated containing the water-insoluble metallic compound grains is passed through the precoat layer and the filter, whereby the precoat layer captures the water-insoluble metallic compound grains,

a detaching water is directed to the precoat layer to detach the precoat layer from the filter, thereby providing a mixture of detached substance of the precoat layer which has captured the water-insoluble metallic compound grains and the detaching water, and

the filter aid is magnetically separated from the mixture, or

wherein (b) in a case where the filter aid forms a deposit layer, together with water-insoluble metallic compound grains, on a filter,

water to be treated containing a metallic ion is alkalified to precipitate water-insoluble metallic compound grains in the water to be treated,

the filter aid is mixed with the water containing the water-insoluble metallic compound grains to provide a suspension of the filter aid and water-insoluble metallic compound grains in the water, and the suspension is filtered through the filter, thereby forming the deposit layer of the filter aid and the water-insoluble metallic compound grains on the filter, whereby the filter aid in the deposit layer captures the water-insoluble metallic compound grains contained in the water,

a detaching water is directed to the deposit layer to detach the deposit layer from the filter, thereby providing a mixture of detached substance of the deposit layer and the detaching water, and

the filter aid is magnetically separated from the mixture.

With the use of the filter aid of the embodiments, it is possible to efficiently separate and eliminate grains which are precipitated from water by a reaction, such as grains of a copper compound such as copper hydroxide, from water to be treated by adsorbing and capturing the grains.

(7) The filter aid for water treatment according to (6) described above, wherein the aggregate has a specific gravity which is larger than that of water. Recovery efficiency of the filter aid is improved when a specific gravity of the aggregate is larger than water since the filter aid hardly flows out of a separation tank in an operation of feeding a mixture of precipitated grains obtained by filtering by a body feed method and the filter aid to the separation tank and stirring the mixture in the separation tank for magnetic separation.

(8) A precoat material for water treatment comprises a filter aid, the filter aid including aggregates of primary particles each comprising a magnetic particle of which surface is coated with a polymer, in which the primary particles have an average diameter D1 which is 0.5 to 20 μm, the aggregates have an average aggregate diameter D2 which satisfies D1<D2≦20 μm, and the polymer has an average surface coating thickness t which satisfies 0.01<t≦0.25 μm,

wherein the precoat material is mixed with a dispersion medium to prepare a suspension of the precoat material in the dispersion medium,

the suspension is filtered through a filter, thereby forming the precoat layer of the precoat material on the filter,

water to be treated containing metallic ions is alkalified to precipitate water-insoluble metallic compound grains in the water to be treated,

passing the water to be treated containing the water-insoluble metallic compound grains through the precoat layer and the filter, whereby the precoat material captures the water-insoluble metallic compound grains contained in the water to be treated,

a detaching water is directed to the precoat layer which has captured the water-insoluble metallic compound grains to detach the precoat layer from the filter, thereby providing a mixture of detached substance of the precoat layer and the detaching water, and

the filter aid is magnetically separated from the mixture.

With the use of the precoat material of the embodiments described herein, it is possible to efficiently separate and eliminate from water to be treated grains precipitated from the water by a reaction, such as grains of a copper compound such as copper hydroxide, by adsorbing and capturing the grains.

(9) The precoat material according to (8) described above, wherein a specific gravity of the filter aid may preferably be larger than water. Recovery efficiency of the filter aid is improved when the specific gravity of the aggregate is larger than water since the filter aid hardly flows out of a separation tank in an operation of feeding a mixture of precipitated grains obtained, for example, by filtering by a precoat method and the filter aid to the separation tank and stirring the mixture in the separation tank for magnetic separation.

(10) A water treatment method of the embodiments comprises:

(a) alkalifying water to be treated containing a metallic ion to precipitate water-insoluble metallic compound grains in the water to be treated;

(b) mixing a filter aid with the water to be treated containing the water-insoluble metallic compound grains to prepare a suspension of the filter aid and the water-insoluble metallic compound grains in the water to be treated, the filter aid comprising aggregates of a primary particles each comprising a magnetic particle of which surface is coated with a polymer, in which the primary particles have an average diameter D1 which is 0.5 to 20 μm, the aggregates have an average aggregate diameter D2 which satisfies D1<D2≦20 μm, and the polymer has an average surface coating thickness t which satisfies 0.01<t≦0.25 μm;

(c) filtering the suspension through a filter to form a deposit layer containing the filter aid and the water-insoluble metallic compound grains on the filter;

(d) directing a detaching water to the deposit layer to detach the deposit layer from the filter, thereby providing a mixture of detached substance of the deposit layer and the detaching water;

(e) magnetically separating the filter aid and the water-insoluble metallic compound grains, which are contained in the mixture; and

(f) recovering the detaching water containing the separated water-insoluble metallic compound grains, and reusing the separated filter aid in the step (b).

The water treatment method of the embodiments described herein is a method corresponding to a body feed method, wherein: water-insoluble metallic compound grains are precipitated from water to be treated; a filter aid satisfying the above-specified numerical value range is dispersed into the water to be treated; the filter aid is allowed to adsorb the water-insoluble metallic compound grains; the water to be treated in a state where the water-insoluble metallic compound grains are adsorbed by the filter aid is supplied to a solid-liquid separation device; filtering is performed by using a filter; and a deposit layer including a mixture of the filter aid and the water-insoluble metallic compound grains is formed on the filter. Subsequently, detaching water is sprayed from a lateral direction onto the deposit layer on the filter to detach the deposit layer from the filter, and the detaching water is further sprayed onto the detached substance to break the detached substance into pieces. Subsequently, the detached substance broken into pieces are fed to the separation tank from the solid-liquid separation device together with the detaching water and stirred in the separation tank so that the detached substance is formed into particles, thereby uniformly dispersing the filter aid and the metallic compound grains in the water. Subsequently, the filter aid dispersed into the water is magnetically adsorbed by a magnetic separation unit (electromagnet or permanent magnet), and the water to be treated containing the metallic compound grains is discharged from the separation tank to a recovery storage tank during the adsorption of the filter aid by the magnetic separation unit. Thus, the metallic compound grains precipitated in the water to be treated are recovered. Meanwhile, the magnetic adsorption of the filter aid is stopped to cause the filter aid to fall off from the electromagnet, and treated water or tap water is sprayed onto the electromagnet to wash and recover the filter aid adhered to the electromagnet. The recovered filter aid is sent from the separation tank to a filter aid supply device to be reused for producing a suspension in the filter aid supply device.

According to the water treatment method of the embodiments descried herein, since the filter aid is particularly excellent in durability, it is possible to repetitively use the filter aid with a cycle of dispersion, adsorption, separation, recovery, and dispersion. Therefore, an advantage of suppressing an operation cost and a maintenance cost is attained.

(11) A water treatment method of the embodiments comprises:

(i) alkalifying water to be treated containing a metallic ion to precipitate water-insoluble metallic compound grains in the water to be treated;

(ii) mixing a filter aid with a dispersion medium to prepare a suspension of the filter aid in the dispersion medium, the filter aid comprising aggregates primary particles each comprising a magnetic particle of which surface is coated with a polymer, in which the primary particles have an average diameter D1 which is 0.5 to 20 μm, the aggregates have an average aggregate diameter D2 which satisfies D1<D2≦20 μm, and the polymer has an average surface coating thickness t which is satisfies 0.01<t≦0.25 μm;

(iii) filtering the suspension through the filter to form a precoat layer of the filter aid;

(iv) passing the water to be treated containing the water-insoluble metallic compound grains through the precoat layer and the filter, whereby the precoat layer captures the water-insoluble metallic compound grains contained in the water to be treated;

(v) directing a detaching water to the precoat layer to detach the precoat layer from the filter, thereby providing a mixture of detached substance of the precoat layer which has captured the water-insoluble metallic compound grains and the detaching water;

(vi) magnetically separating the filter aid and the water-insoluble metallic compound grains, which are contained in the mixture; and

(vii) recovering the detaching water containing the separated water-insoluble metallic compound grains, and reusing the separated filter aid in the step (ii).

The water treatment method of the embodiments described herein is a method corresponding to a precoat method, wherein: the precoat material satisfying the above-specified numerical value range is dispersed into a dispersion medium such as water to supply the dispersion solution to a solid-liquid separation device; the precoat material is deposited on a filter to form a desired precoat material layer while causing water-insoluble metallic compound grains to be precipitated from water to be treated by a reaction; and the water to be treated containing the precipitated water-insoluble metallic compound grains is passed through the precoat material layer so that the water-insoluble metallic compound grains are adsorbed and captured by a filter aid. Subsequently, detaching water is sprayed from a lateral direction onto the precoat material layer on the filter to detach the precoat material layer from the filter, and the detaching water is further sprayed onto the detached substance to break the detached substance into pieces. Subsequently, the detached substance broken into pieces are fed to a separation tank from the solid-liquid separation device together with the detaching water and stirred in the separation tank so that the detached substance is formed into particles, thereby uniformly dispersing the filter aid and the metallic compound grains in the water. Subsequently, the filter aid dispersed into the water is magnetically adsorbed by an electromagnet, and the water to be treated containing the metallic compound grains is discharged from the separation tank to a recovery storage tank during the adsorption of the filter aid by the magnetic separation unit. Thus, the metallic compound grains precipitated in the water to be treated are recovered. Meanwhile, the magnetic adsorption of the filter aid is detached to cause the filter aid to fall off from the electromagnet, and treated water or tap water is sprayed onto the electromagnet to wash and recover the filter aid adhered to the electromagnet. The recovered filter aid is sent from the separation tank to a filter aid supply device to be reused for producing a suspension in the filter aid supply device.

According to the water treatment method of the embodiments descried herein, since the precoat material is particularly excellent in durability, it is possible to repetitively use the precoat material with a cycle of dispersion, adsorption, separation, recovery, and dispersion. Therefore, an advantage of suppressing an operation cost and a maintenance cost is attained.

Hereinafter, various preferred embodiments will be described with reference to the accompanying drawings.

In the embodiments and Examples described hereinafter, an flocculant and an alkali are added to water to be treated containing fine solid particles (average diameter: 0.01 to 10 μm) and various solutes such as a metallic ion or a nonmetallic ion to generate an aggregate by aggregation of the solid particles or to precipitate particles (average diameter 0.01 to 10 μm) of a metallic or nonmetallic compound salt. The types of the flocculant and the alkali are not particularly limited. The direct addition of flocculant and alkali reduces the diameter of the aggregate to be aggregated or the metallic or nonmetallic grains to be precipitated, thereby making it considerably difficult to separate it/them from water. However, with the use of a resin composite of the present embodiment, advantages of a reduction in number of steps and simplification of an apparatus configuration are attained since it is possible to continuously or semi-continuously and semi-intermittently eliminate these fine water-insoluble substances.

There are two types of water treatment methods, namely a precoat method and a body feed method, which use the resin composite of the present embodiment, and apparatuses used for the methods are different in configuration from each other.

Therefore, each of the methods will hereinafter be described.

### First Embodiment

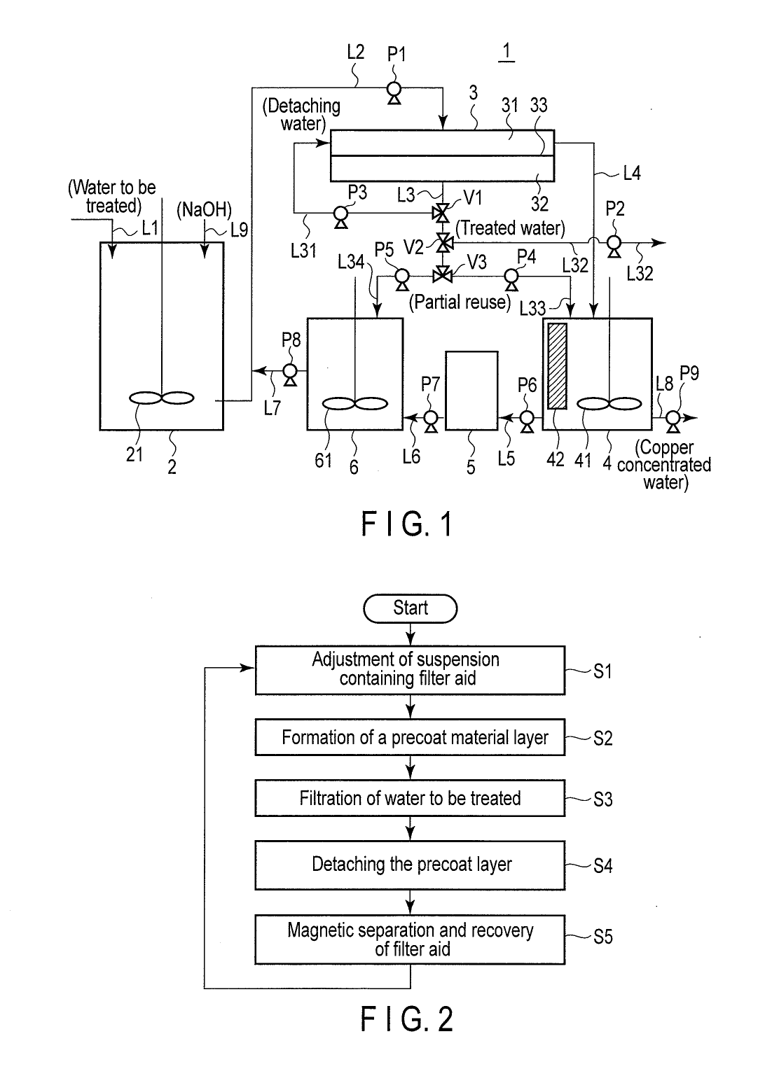

To start with, a water treatment apparatus to be used in a first embodiment will be described with reference to FIG. 1.

A water treatment apparatus 1 of the present embodiment is the one used for the precoat method and is particularly effectively used in the case where a concentration of a water-insoluble substance in water to be treated is low. The water treatment apparatus 1 has an aggregation and precipitation tank 2, a solid-liquid separation device 3, a separation tank 4, a filter aid tank 5, a mixing tank 6, a raw water supply source (not shown), an flocculant adding device (or an alkali adding device) (not shown), and a concentrated water storage tank (not shown), and the units and the devices are connected to one another by a plurality of piping lines L1 to L8. To the piping lines L1 to L8, various pumps P1 to P9, valves V1 to V3, measuring instruments (not shown), and sensors (not shown) are provided. Detection signals from the measuring instruments and the sensors are inputted to an input unit of a controller (not shown), and control signals are outputted from an output unit of the controller to the pumps P1 to P9 and the valves V1 to V3, so that operations of the pumps P1 to P9 and the valves V1 to V3 are controlled. The water treatment apparatus 1 as a whole is controlled in the integrated manner as described above by the not-shown controller.

The aggregation and precipitation tank 2 has a stirring screw 21 for stirring the water to be treated. Plant effluent which is the water to be treated is introduced thereinto through the line L1 from the not-shown raw water supply source, and an appropriate amount of an flocculant is added from the not-shown flocculant adding device during temporary storage of the water to be treated. Thus, the aggregation and precipitation tank 2 aggregates fine solid particles contained in the water to be treated. Further, an appropriate amount of an alkali agent is added from the not-shown alkali adding device to the aggregation and precipitation tank 2, and a metallic ion or a nonmetallic ion contained in the water to be treated is precipitated as grains of a compound salt.

The solid-liquid separation device 3 internally has a filter 33 which partitions an internal part into an upper space 31 and a lower space 32. The upper space 31 of the solid-liquid separation device is connected to the aggregation and precipitation tank 2 via the water to be treated supply line L2 having the pressure pump 1. Further, a detaching water supply line L31 having the pump P5 and the detached substance discharge line L4 are connected to a lateral part of the upper space 31.

The discharge space 32 of the solid-liquid separation device is connected to the water to be treated distribution line L3 having the three three-way valves, V1, V2, and V3. The above-described detaching water supply line 31 is branched from the water to be treated distribution line L3 at the first three-way valve V1. A water to be treated line L32 having the pump P2 is branched from the water to be treated distribution line L3 at the second three-way valve V2. Two lines L33 and L34 are branched from the water to be treated distribution line L3 at the third three-way valve V3. One of the branch lines 33 has the pump P4 and is connected to the separation tank 4 which is described below. The other branch line L34 has the pump P5 and is connected to the mixing tank 6 described below.

The separation tank 4 has a stirring screw 41 for stirring discharged water received from the upper space 31 of the solid-liquid separation device via the detached substance discharge line L4 and internally has an electromagnet 42 for separating a precipitated copper compound from a filter aid. The electromagnet 42 is connected to a power source (not shown) which is turned on and off under the control by the not-shown controller.

The branch line L33 branched from the treated water distribution line L3 is connected to an upper part of the separation tank 4 in addition to the detached substance discharge line L4, and a part of the treated water which has passed through the filter 33 of the solid-liquid separation device is supplied to the separation tank 4 so that the treated water is partially reused in the separation tank 4. The concentrated water discharge line L8 and the filter aid returning line L5 are connected to a lower part of the separation tank 4. The concentrated water discharge line L8 has the pump P9 and serves as the piping for discharging concentrated water-insoluble substance water to a storage tank (not shown) from the separation tank 4. The filter aid returning line L5 has the pump P6 and serves as the piping for returning the separated filter aid from the separation tank 4 to the filter aid tank 5.

The filter aid tank 5 has such a configuration that a new filter aid is supplied from a filter aid supply source (not shown) and the filter aid separated in the separation tank 4 is returned through the above-described filter aid returning line L5. Further, the filter aid tank 5 supplies an appropriate amount of the filter aid to the mixing tank 6 through the filter aid supply line L6 having the pump P7.

The mixing tank 6 has a stirring screw 61 for stirring water and prepares a mixture (suspension) containing the filter aid by adding a dispersion medium to the filter aid supplied from the filter aid tank 5 and performing stirring and mixing. Water may preferably be used as the dispersion medium. The branch line 34 branched from the treated water distribution line L3 is connected to an upper part of the mixing tank 6, and a part of the treated water which has passed through the filter 33 of the solid-liquid serration device is supplied to the mixing tank 6 so that the treated water is partially reused as the dispersion medium in the mixing tank 6.

Further, a communication is provided between an appropriate part of the mixing tank 6 and the suspension supply line L7 having the pump P8. The suspension supply line L7 is connected to and joins at an appropriate point on the water to be treated supply line L2. Thus, the filter aid-containing mixture (suspension) from the suspension supply line L7 is added to the water to be treated flowing through the water to be treated supply line L2. A flow rate control valve (not shown) is provided on the suspension supply line L7, and a flow rate of the suspension is adjusted by the controller.

### (Water Treatment Method of First Embodiment)

Hereinafter, a water treatment method of the first embodiment using the above-described apparatus will be described with reference to FIG. 2 and FIG. 1.

The precoat method is particularly effective for the case in which a concentration of a water-insoluble substance contained in water to be treated is low. The water-insoluble substance in the present embodiment may be an organic substance or an inorganic substance without particular limitation. Further, it is unnecessary to increase a diameter of grains to be precipitated by performing a special operation such as addition of a crystal core during the precipitation nor to perform aggregation by adding a chemical such as an flocculant since a resin composite of the embodiment is designed to be capable of eliminating grains precipitated from the water as they are. Particularly, the present embodiment is particularly suitable for use for calcium fluoride which is precipitated by a reaction between a fluorine ion in the water and a calcium ion as well as for a heavy metal compound which is precipitated by reduction or oxidation of a heavy metal ion in the water or by a salt with another ion. Since concentration regulations of these substances are severe, they are precipitated under a relatively low concentration environment in order that precipitated particles have a small diameter. Further, even though hardly dewaterable particles such as a hydroxide of a heavy metal or a hardly dewaterable component except the particles, such as oil, are present, such substance can be readily filtered out due to the structure of the resin composite. It is preferable to appropriately select a polymer depending on the type of effluent.

In the water treatment method of the present embodiment, a certain operation is performed on water containing a water-soluble impurity to be eliminated to cause a reaction such as oxidation, reduction, and neutralization of the water-soluble impurity, thereby changing the impurity into a water-insoluble one. The substance which is changed into the water-insoluble substance (water-insoluble substance) by the above-described operation is precipitated in the water as fine particles, and a part of particles are aggregated to be dispersed into the water as particles having the size of about one micron.

In the precoat method, a magnetic material-containing filter aid and a dispersion medium are mixed in the mixing tank 6 to prepare a suspension containing the filter aid (Step S1). The filter aid may contain magnetic material particles and a polymer coating the magnetic material particles. Water is mainly used as the dispersion medium, but other dispersion mediums may be used as required. A concentration of the filter aid in the suspension is adjusted to be about 10000 to 200000 mg/L which is not limitative insofar as it is possible to form a precoat layer, i.e., a particle deposit layer by the following operation.

Subsequently, the suspension is passed through the filter 33 of the solid-liquid separation tank 3 to cause the filter aid in the suspension to be separated by filtering and to remain on the filter, thereby forming the particle deposit layer (precoat material layer) which includes aggregated filter aid (Step S2). The passing of water to the filter 33 by the pressure pump P1 is performed at a predetermined pressure.

The filter 33 is attached in such a manner as to close an inlet of the solid-liquid separation device 3, and the filtering of the suspension by the filter 33 is performed while suppressing a pressure reduction of the suspension to be as small as possible. More specifically, the upper space 31 of which a periphery is defined by a container wall of the solid-liquid separation device 3 and the filter 33 is downsized, and the pressurized suspension is press-flown into the narrow space 31 having the smaller volume, so that the separation between the solid (filter aid) and the liquid by the filter 33 is accelerated. Here, by the synergy effect between the pressure caused by the driving of the pressure pump P1 and the gravity, the liquid component of the suspension rapidly passes through the filter 33, and the solid component (filter aid) of the suspension is captured by the filter 33, resulting in formation of the precoat layer including the filter aid on the filter 33. A thickness of the precoat material layer is generally about 0.5 to 10 mm though it is subject to change due to the concentration of the liquid to be treated.

Meanwhile, water to be treated containing a copper ion is introduced into the precipitation tank 2, and sodium hydroxide (NaOH) is added to alkalify the water to be treated, thereby causing copper hydroxide to be precipitated from the water to be treated in the precipitation tank 2.

It is estimated that the copper hydroxide precipitation reaction is represented by the following equation (1).

Cu²⁺+2NaOH→Cu(OH)₂↓(precipitation)+2Na⁺ (1).

However, in the case where the solution is acidic, the copper hydroxide precipitate (copper hydroxide grains) obtained by the reaction of equation (1) is dissolved due to a reaction with an acid as represented by the following equation (2), and, therefore, it is impossible to obtain the copper hydroxide grains. Further, since the number of hydroxide groups is small in a neutral range, the reaction of the equation (1) is not promoted, resulting in failure in obtaining the copper hydroxide grains. The copper hydroxide grains are generated as the precipitate in the solution only when pH of the solution is within the alkaline range. In the case where the solution is alkaline, the copper hydroxide grains are stably precipitated from the solution in accordance with the equation (1).

Cu(OH)₂+H₂SO₄→CuSO₄+2H₂O (2).

The water to be treated containing the copper hydroxide grains precipitated as described above is press-fed from the precipitation tank 2 to the solid-liquid separation device 3 through the line L2 by the driving of the pressure pump P1 so that the water to be treated is filtered through the filter 33 and the precoat layer (Step S3). Here, the copper hydroxide grains in the water to be treated are captured by the filter aid in the precoat layer.

The passing of the water to be treated through the precoat layer on the filter 33 is mainly performed under an increased pressure. Here, the copper hydroxide grains are adsorbed on a surface of the filter aid in the precoat layer to be separated and eliminated from the water to be treated. Here, it is possible to efficiently capture the copper hydroxide grains and to attain a satisfactory water passing speed by using the filter aid having the special structure as described later in this specification.

Subsequently, the valve V1 is switched to start up the pump P3, and a part or whole of the treated water is returned to the upper space 31 of the solid-liquid separation device through the lines L3 to L31 by the driving of the pump P3. The returned treated water is used as detaching water for detaching the precoat layer from the filter 33. The treated water (detaching water) is sprayed onto the precoat layer from a lateral direction of the upper space 31 to detach the precoat layer from the filter 33, and the treated water is further sprayed onto the detached substance to break the detached substance into pieces, thereby dispersing the filter aid and the copper hydroxide grains into a dispersion medium (Step S4).

The detach and separation of the precoat layer may be performed in the container in which the filter is installed or in another container. In the case of performing the detach and separation of the precoat layer in another container, the precoat layer is broken into pieces by using a spray nozzle or the like and then transported. When water to be treated is insufficient, water may be supplied to line L31 from another place. It is preferable to use water for the detach and separation of the precoat layer, but a surfactant or an organic solvent may be used for detaching and separating the precoat layer.

The suspension containing the pieces of the precoat layer is fed to the separation tank 41 through the line L4 from the upper space 31, and the pieces of the precoat layer are stirred by the stirring screw 41 in the separation tank 4 to be further broken into a particle level, thereby dispersing the filter aid and the copper hydroxide grains. With the satisfactory stirring, the filter aid and the copper hydroxide grains are more uniformly dispersed into the suspension to facilitate separation of the filter aid.

Subsequently, the filter aid is recovered from the suspension after the detach and breaking of the precoat layer by using a magnetic separation method (Step S5). The magnetic separation method is not particularly limited, and examples thereof include a method of recovering the filter aid by using a permanent magnet or an electromagnet placed in the container of the separation tank 4, a method of recovering the filter aid by using a magnetized metallic mesh and recovering the grains by detaching a magnetic field, and the like. More specifically, the electromagnet 42 is turned on to cause the filter aid to be adsorbed and fixed by the electromagnetic 42 in the suspension, and concentrated copper water is discharged to the storage tank (not shown) through the line L8 from the container of the separation tank 4. Subsequently, the electromagnet 42 is turned off to cause the filter aid to fall off from the electromagnet 42, and a part of the treated water is supplied from the solid-liquid separation device 3 to the container through the line L32 to add the treated water to the fallen filter aid, thereby obtaining a slurry or a suspension. The filter aid in the form of the slurry or suspension is fed to the filter aid supply device 5 from the separation tank 4 through the line L5. Alternatively, after the adsorption and fixation by the electromagnet 42, the electromagnet 42 including the filter aid are transferred to another container, and the electromagnet 42 is turned off in the container to cause the filter aid to fall off from the electromagnetic 42, thereby recovering the filter aid in the container.

After that, the recovered filter aid is supplied to the upper space 31 of the solid-liquid separation device 3 from the filter aid supply device 5 through the line L6 to reuse the recovered filter aid for forming the precoat layer. As described above, it is possible to repetitively use the filter aid with the cycle of precoat layer formation, capture of copper precipitate, separation from copper precipitate, recovery, and precoat layer formation.

In the water treatment method of the present embodiment, since the water to be treated is passed after the formation of the precoat material layer on the filter, the amount of the water-insoluble substance to be adsorbed on the surface of the filter aid is increased along with an increase in treatment time. As a result, since the particularly excessively adsorbed water-insoluble substance fills up the clearances between the filter aids, the water passing speed is decreased. Therefore, as described in the foregoing, the water treatment method of the present embodiment is effective for the case in which the concentration of the water-insoluble substance in the water is low.

### (Resin Composite)

Hereinafter, the resin composite will be described in detail.

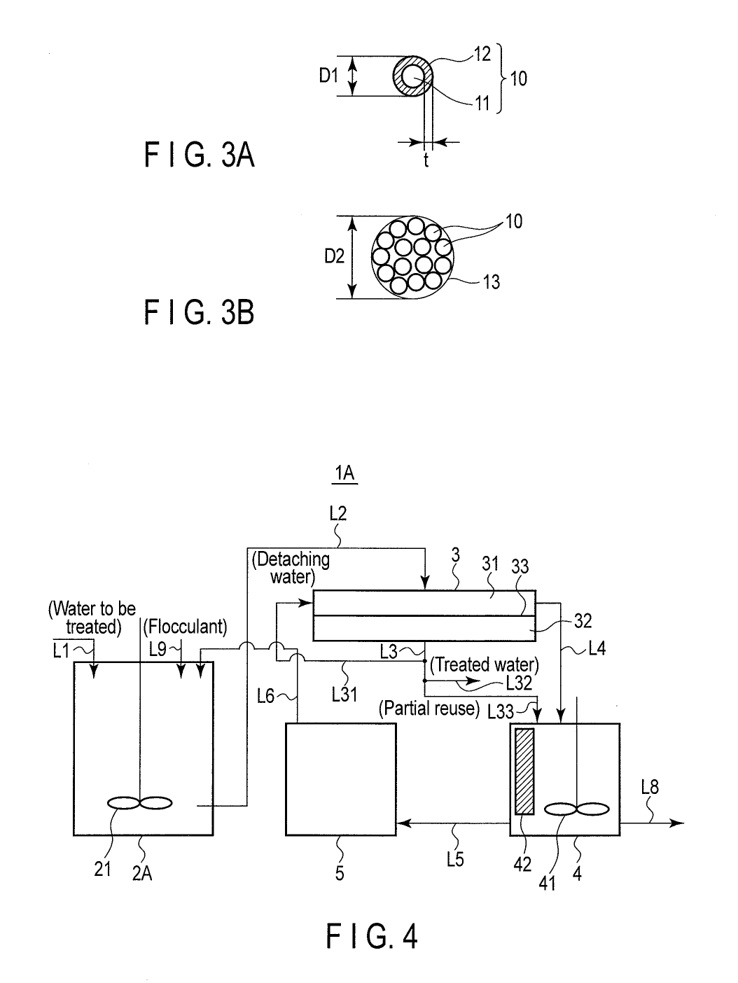

The resin composite includes magnetic material particles, and an average diameter thereof is within a range of 0.5 to 20 p.m. The resin composite may be primary particles 10 which are obtainable by covering a surface of a magnetic powder 11 with a polymer 12 as shown in FIG. 3A. In short, the resin composite forms the primary particles 10 having a core/shell structure in which the magnetic powder 11 is the core, and the polymer 12 covering the surface of the magnetic powder 11 forms the shell. Further, the resin composite may be an aggregate 13 obtainable by aggregating the magnetic material particles 11 covered with a polymer as shown in FIG. 3B. In short, the resin composite forms a secondary aggregate which is obtainable by aggregating a multiple of the primary particles having the core/shell structure.

The magnetic powder which is the core of the primary particles is not particularly limited insofar as it is made from a magnetic material. The magnetic material to be used may desirably be a substance which exhibits ferromagnetism in a room temperature range. However, the magnetic material is not limited to the above, and it is possible to use general ferromagnetic substances such as iron, an alloy containing iron, a magnetic steel (magnetite), a titanium steel, magnetic sulfur steel, magnesia ferrite, cobalt ferrite, nickel ferrite, barium ferrite, and the like. Among these, the ferrite compounds which are excellent in stability in water enable a more effective water treatment. For example, magnetite (Fe₃O₄) which is a magnetic steel is preferred since it is not only inexpensive but also easily usable for the water treatment due to its stability as a magnetic material in water and safety as an element.

A shape of the magnetic powder may be a spherical shape, a polyhedral shape, an infinite shape, or the like without particular limitation thereto. Preferred particle diameter and shape of the magnetic carrier to be used may appropriately be selected in view of a production cost and the like, and the spherical shape and a polyhedral shape with rounded angles are particularly preferred. The magnetic powder may be subjected to an ordinary plating treatment such as Cu plating and Ni plating as required.

The magnetic powder to be used has an average diameter within a range of 0.5 to 20 μm. Here, the average diameter is measured by employing a laser diffractometry. More specifically, it is possible to conduct the measurement by using SALD-DS21 type measurement device (trade name) manufactured by Shimadzu Corporation, or the like. When the average diameter of the magnetic powder exceeds 20 μm, a distance between the particles is increased to allow fine precipitates in water described later in this specification to readily pass through. In contrast, when the particle diameter is less than 0.5 μm, the primary particles are densely aggregated to make it impossible to attain effective a water passing rate.

By the incorporation of the magnetic powder, a specific gravity of the resin composite becomes relatively high to enable combined use of sedimentation by gravity or separation by centrifugal force using cyclone with the magnetic separation, thereby making it possible to rapidly separate the resin composite from the water.

In the embodiment, as the polymer used for coating the surfaces of the magnetic power and aggregating the magnetic powder, a material having optimum properties may be selected depending on the objective. It is preferable to use polyacrylonitrile, polymethylmethacrylate, polystyrene, or a copolymer thereof, which is easily coated on a magnetic powder and has acid resistance and alkali resistance, a phenol resin having excellent dispersibility into water, or a trialkoxysilane condensate which has high safety in water due to its capability of being firmly adhering to the magnetic powder. The magnetic material particles 10 are coated with the polymer in such a manner that an average surface coating thickness t of the polymer is kept within a range of 0.01≦t≦0.25 μm. When the polymer average surface coating thickness t is less than 0.01, strength of a secondary aggregate 13 is reduced to make it difficult to use the resin composite in water. In contrast, when the polymer average surface coating thickness t exceeds 0.25 μm, the clearance between the particles is reduced to make it impossible to ensure the effective water passing rate when used as a filter aid. A coating amount of the polymer may be calculated by observation using an optical microscope or a SEM, but it is preferable to accurately detect the polymer coating amount by: heating a resin composite in an oxygen-free state to cause heat decomposition; detecting a weight reduction, i.e., the polymer coating amount; and calculating an average thickness of a polymer layer from specific surface of the particles 11.

The resin composite comprises the secondary aggregate 13 which is obtainable by aggregating the primary particles 10 obtained by coating the above-described magnetic power 11 with the above-described polymer 12 (FIGS. 3A and 3B). The secondary aggregate 13 may preferably have a characteristic shape. More specifically, in the resin composite, an average aggregate diameter D2 of the aggregate 13 satisfies a relationship of D1<D2≦20 μm when the average diameter of the primary particles 10 is D1. When the aggregation is conducted to satisfy the above-specified size, the primary particles 10 are not aggregated into a regular spherical shape as the secondary aggregate 13, but an irregular shape is formed. The irregular shape makes it possible to ensure appropriate clearances in a precoat material layer when the resin composite is used as the filter aid or the precoat material, thereby making it possible to entrap substances in the water. The average aggregate diameter D2 of the aggregate 13 may more preferably be with a range of D1<D2≦15 μm. When the average aggregate diameter D2 is more than 15 μm, a size of each of clearances in the aggregate 13 is increased to make it difficult to entrap the precipitate in the water. When the aggregation is not attained at all, a uniform filtering layer is formed to prevent the precipitate from entering an internal part of the filtering layer, and the precipitate is deposited on an upper part of the filtering layer to make the filtering difficult, thereby making it impossible to attain the passing speed.

The resin composite may be produced by an arbitrarily selected method insofar as the method enables to realize the above-described structure of the resin composite. As one of examples of the method, a spray drying method may be employed, in which: the polymer is dissolved into an organic solvent which is capable of dissolving the polymer; a composition is prepared by dispersing the magnetic powder into the solution; and the organic solvent is eliminated by spraying the composition. According to the method, it is possible to adjust an average diameter of the secondary aggregate obtainable by aggregating the primary particles by adjusting an ambient temperature and a spray speed of the spray drying, and, further, it is possible to easily form a suitable porous structure since pores are formed when the organic solvent is eliminated from the clearances between the aggregated primary particles 10.

Further, it is possible to form the resin composite by: preparing a polymer solution by dissolving the polymer into a solvent which is capable of dissolving the polymer; casting the polymer solution on a surface of the magnetic power placed in a mold or the like; and pulverizing a solidified material obtained by eliminating the solvent or pulverizing a solidified material obtained by eliminating the organic solvent from a composition obtainable by dispersing the magnetic powder into the polymer solution. Further, it is possible to produce the resin composite by dropping a composition obtainable by dissolving the polymer into a solvent into a Herschel mixer, a ball mill, or a granulator, followed by drying. Here, it is possible to produce the preferred resin composite by performing two steps including production conditions which enable to cover the surfaces of the magnetic powder with the polymer and conditions which enable to aggregate the magnetic powder.

Hereinafter, a method of adjusting the polymer coating thickness and a method of adjusting the aggregate diameter of the aggregate obtained by aggregating the polymer coated magnetic material particles in the production will be described.

In order to decide a surface coating thickness on the surface of the magnetic material in the production, the surface coating thickness is calculated from a mixing ratio between the polymer and the magnetic material, a density of the resin, and a specific surface of the magnetic material. In other words, the average coating thickness t of the polymer is determined by obtaining a volume of the resin to be added from the weight and the density of the resin to be added and dividing the volume by a surface area of the magnetic material obtained from the weight and the specific surface of the magnetic material. Further, though control of the particle diameter is varied depending on the type of the liquid to be sprayed and the spraying method, it is possible to downsize the aggregate by reducing a diameter of a droplet to be subjected to the spray drying, and the particle diameter of the aggregate to be produced is reduced by increasing a spray pressure of the spray nozzle, reducing a spray speed, or increasing revolution of the spray disk.

Hereinafter, a method for measuring a polymer coating thickness of a completed aggregate will be described.

Calculation of the coating thickness of the polymer may be conducted by observation by using an optical microscope or a SEM, but it is preferable to accurately detect the polymer coating thickness by: heating a resin composite in an oxygen-free state to cause heat decomposition; detecting a weight reduction, i.e., the polymer coating amount; and calculating an average thickness of a polymer layer from specific surfaces of the particles.

### Second Embodiment

A water treatment apparatus 1A to be used for a water treatment method of the second embodiment will be described with reference to FIG. 4. Description for the part which overlaps with the foregoing embodiment will not be repeated.

The water treatment apparatus 1A of the present embodiment is used for the body feed method and particularly effectively used for the case in which a concentration of a water-insoluble substance in water is high. The apparatus 1A of the present embodiment differs from the apparatus 1 of the first embodiment by the feature of omitting the mixing tank 6 and providing a mixing and precipitating tank 2A in place of the aggregation and precipitation tank 2. The mixing and precipitating tank 2A has a precipitation function of adding an alkali to water to be treated and precipitating a compound salt and a mixing function of adding a filter aid to the water to be treated and mixing them. In short, in the apparatus 1A of the present embodiment, the filter aid is directly supplied to the mixing and precipitating tank 2A from a filter aid tank 5 through a line L6 without passing through any mixing tank.

### (Second Water Treatment Method)

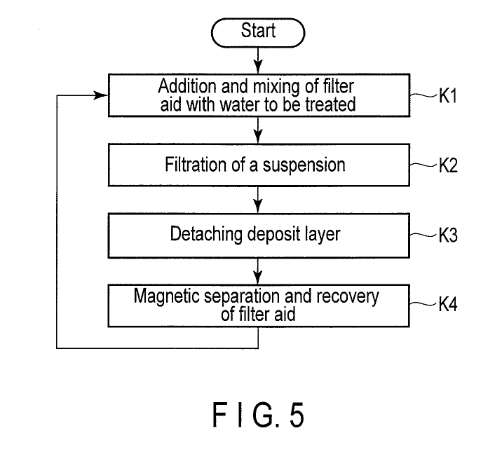

A body feed method using the apparatus described above will be explained as the second water treatment method with reference to FIG. 4 and FIG. 5.

A suspension is firstly prepared in the present embodiment, too, by mixing the filter aid and a dispersion medium, and the dispersion medium to be used in this case is the water to be treated which is retained in the mixing and precipitating tank 2A. In other words, in the present method, the filter aid is directly added to raw water which is the water to be treated, and the suspension is prepared from the raw water (Step K1). A concentration of the filter aid in the suspension may be adjusted to about 10000 to 200000 mg/L, for example, though the concentration is not particularly limited insofar as a filter layer is formed by the method described below.

Subsequently, the suspension (water to be treated) is passed through a filter, and the filter aid in the suspension is separated to remain on the filter, thereby forming the filter layer resulted from aggregation of the filter aid (Step K2). The water passing is performed under an increased pressure.

Since the filter layer is formed and maintained by the external action as described above, the above-described filtering is performed in such a manner that the filter is disposed so as to cover an inlet of a predetermined container, whereby the filter aid remains on the filter, is aligned, and is layered on the thus-disposed filter. In this case, the filter layer is formed and maintained by an external force from a wall surface of the container and a downward external force (gravity) caused by a weight of the filter aid positioned above.

After eliminating the water-insoluble substance in the water to be treated as described above, the filter layer is dispersed into a dispersion medium to break the filter layer into the filter aid, and the filter aid is washed (Step K3). The washing may be performed in the container in which the filter 33 is installed, or in another container. In the case of performing the washing in another container, the filter layer is broken into the filter aid by using a procedure such as a washing and then transported. Water is used for the washing, but a surfactant or an organic solvent may be used for the washing.

Subsequently, the filter aid after the washing is recovered by employing magnetic separation (Step K4). A method for the magnetic separation is not particularly limited, and examples thereof include a method of recovering the filter aid by using a permanent magnet or an electromagnet placed in the container, a method of recovering the filter aid by using a magnetized metallic mesh and recovering the particles by detaching a magnetic field, and the like.

In the second water treatment method, since the filter aid forming the filter layer is contained in the water to be treated, i.e. in the suspension prepared by using the water, the aggregate is continuously supplied together with the water to be treated (suspension) containing the water-insoluble substance to be eliminated.

Therefore, even though an amount of the water-insoluble substance in the water to be treated (suspension) is large, the excessively adsorbed water-insoluble substance does not fill up clearances of the filter aids unlike the first embodiment described above since the water-insoluble substance supply and the filter aid supply are simultaneously performed. Therefore, it is possible to maintain a filtering speed for a long time. As a result, the water treatment method of the second embodiment is effective for the case in which the water-insoluble substance concentration in the water to be treated is high as described above.

Further, in each of the first and second water treatment methods, it is easy to perform the washing (desalination treatment) of the water-insoluble substance to be recovered. More specifically, it is possible to eliminate the ionic component adhered to the water-insoluble substance by passing water through the filter aid and the water-insoluble substance deposited on the filter for a certain period of time.

Hereinafter, resin composites of Examples and Comparative Example shown in Table 1 will be described in detail.

### Resin Composite Production

### Example: Resin Composite A

A solution was prepared by dissolving 30 parts by weight of polystyrene (density: 1.05 g/cm³) into 3 L of tetrahydrofuran, and 300 parts by weight of magnetite particles (specific surface: 2.5 m²/g) having an average diameter of 2 μm were dispersed into the solution to obtain a composition. The composition was slowly sprayed by using a mini-spray drier (B-290 type manufactured by Shibata Scientific Technology Ltd.) to produce a resin composite aggregated in the form of a sphere and having an average secondary particle diameter of about 8 μm. An average coating thickness calculated from the density of polystyrene and the specific surface of magnetite was 38 nm.

### Example: Resin Composite B

A resin composite was produced in the same manner as in Resin Composite A except for changing the type of the resin to a polyacrylonitrile styrene copolymer (30 parts by weight) (density: 1.05 g/cm³). An average aggregate diameter was about 7 μm, and an average coating thickness was 38 nm.

### Example: Resin Composite C

A resin composite was produced in the same manner as in Resin Composite A except for changing the type of the resin to polymethylmethacrylate (30 parts by weight) (density: 1.20 g/cm³). An average aggregate diameter was about 6 μm, and an average coating thickness was 33 nm.

### Example: Resin Composite D

A resin composite was produced in the same manner as in Resin Composite C except for changing the weight of the resin to 10 parts by weight. An average aggregate diameter was about 2.4 μm, and an average coating thickness was 11 nm.

### Example: Resin Composite E

A resin composite was produced in the same manner as in Resin Composite C except for changing the weight of the resin to 50 parts by weight. An average aggregate diameter D2 was about 18 μm, and an average coating thickness was 0.055 μm (C).

### Example: Resin Composite F

A resin composite was produced in the same manner as in Resin Composite C except for changing the weight of the resin to 220 parts by weight. Since an average aggregate diameter was about 80 μm, the resin composite was pulverized by using a pulverizer, followed by sieving, thereby obtaining a resin composite having an average aggregate diameter of about 14 μm. An average coating thickness was 242 nm.

### Example: Resin Composite G

A solution was prepared by dissolving 40 parts by weight of a resol phenol resin (density when cured: 1.2 g/cm³) into 3 L of water, and 300 parts by weight of magnetite particles (specific surface: 2.5 m²/g) having an average diameter of 2 μm (A) were dispersed into the solution to obtain a composition. The composition was slowly sprayed by using a mini-spray drier (B-290 type manufactured by Shibata Scientific Technology Ltd.) to produce a resin composite aggregated in the form of a sphere and having an average secondary particle diameter of about 8 μm. An average coating thickness calculated from the density of the polyphenol resin and the specific surface of magnetite was 44 nm.

### Example: Resin Composite H

A solution was prepared by dissolving 100 parts by weight of phenyltriethoxysilane into 3000 mL of water and 10 parts by weight of acetic acid, and 300 parts by weight of magnetite particles (specific surface: 2.5 m²/g) having an average diameter of 2 μm (A) were dispersed into the solution to obtain a solution. The solution was sprayed by using a mini-spray drier (B-290 type manufactured by Shibata Scientific Technology Ltd.) to produce a resin composite aggregated in the form of a sphere and having an average secondary particle diameter D2 of 10 μm. A calculated average coating thickness was 25 nm.

### Example: Resin Composite I

A resin composite was produced in the same manner as in Resin Composite C except for changing the average diameter of magnetite to 0.5 μm (specific surface: 5.2 m²/g). An average aggregate diameter D2 was about 5 μm, and an average coating thickness was 16 nm.

### Example: Resin Composite J

A resin composite was produced in the same manner as in Resin Composite C except for changing the average diameter of magnetite to 5 μm (specific surface: 0.7 m²/g). An average aggregate diameter D2 was about 16 μm, and an average coating thickness was 119 nm.

### Comparative Example: Resin Composite K

A resin composite having a larger particle diameter was produced in the same manner as in Resin Composite C except for changing the spray speed. An average aggregate diameter was about 26 μm, and an average coating thickness was 33 nm.

TABLE 1
Structures of various resin composites

| | | | Average secondary | |
|---|---|---|---|---|
| | | | particle diameter | |
| | | | or average aggregate | Average coating |
| Type | Sample | Composition | diameter (μm) | thickness (nm) |
| Example | A | Polystyrene + magnetite | 8 | 38 |
| Example | B | Polyacrylonitrile + magnetite | 7 | 38 |
| Example | C | Polymethylmethacrylate + magnetite | 11 | 33 |
| Example | D | Polymethylmethacrylate + magnetite | 2.4 | 11 |
| Example | E | Polymethylmethacrylate + magnetite | 18 | 55 |
| Example | F | Polymethylmethacrylate + magnetite | 14 | 242 |
| Example | G | Resol phenol + magnetite | 8 | 44 |
| Example | H | Phenyltriethoxysilane + magnetite | 10 | 25 |
| Example | I | Polymethylmethacrylate + magnetite | 5 | 16 |
| Example | J | Polymethylmethacrylate + magnetite | 16 | 119 |
| Comparative | K | Polymethylmethacrylate + magnetite | 26 | 33 |
| Example | | | | |

### Water Treatment Using Resin Composite

### Example 1

To effluent containing 1000 ppm of copper sulfate, sodium hydroxide was added to adjust pH to pH 11, followed by precipitation of copper hydroxide. 5000 ppm of Resin

Composite A was mixed with this water, and pressure filtration was performed by using a filter cloth having an aperture size of about 1 μm to eliminate copper hydroxide and copper oxide by employing the body feed method. It was confirmed that 99% or more of copper in the water was eliminated.

Subsequently, water was mixed with a layer deposited on the filter cloth to obtain a mixture liquid of the resin composite and the copper precipitate, and the mixture liquid was transferred to another container to remove the resin composite by using a permanent magnet. It was confirmed that copper hydroxide and a water-insoluble substance other than the copper hydroxide were separated from each other in the water. The removed resin composite was used again, and it was confirmed that the reuse was satisfactory.

### Example 2

To effluent containing 100 ppm of copper sulfate, sodium hydroxide was added to adjust pH to pH 11, followed by precipitation of copper hydroxide. Separately, a slurry in which 10000 ppm of Resin Composite A was dispersed into water was prepared, and pressure filtration was performed by using a filter cloth having an aperture size of about 1 μm to prepare a precoat layer of the resin composite. Subsequently, the effluent was passed through the precoat layer. It was confirmed that copper hydroxide and a water-insoluble substance other than the copper hydroxide were eliminated, and 99% or more of copper in the water was eliminated. Subsequently, water was mixed with the precoat layer deposited on the filter cloth to obtain a mixture liquid of the resin composite and the copper precipitate, and the mixture liquid was transferred to another container to remove the resin composite by using a permanent magnet. It was confirmed that copper hydroxide and a water-insoluble substance other than the copper hydroxide were separated from each other in the water. The removed resin composite was used again, and it was confirmed that the reuse was satisfactory.

### Examples 3 to 11

Water treatments were performed in the same manner as in Example 1 except for changing the type of the resin composite to Resin Composites B to J. It was confirmed that 99% or more of copper in the water was eliminated and the reuse was satisfactory.

### Comparative Example 1

A water treatment was performed in the same manner as in Example 1 except for changing the type of resin composite to Resin Composite K of Comparative Example. It was confirmed that copper hydroxide eluted off to the filtrate and that only 55% of copper in the water was eliminated.

### Comparative Example 2

The pressure filtration was performed in the same manner as in Example 1 except for not using the resin composite, the filter cloth was shortly clogged with copper hydroxide, thereby failing to attain a satisfactory water passing rate.

### Example 12

Effluent containing 1000 ppm of a fluoride ion was passed through a column charged with calcium carbonate to obtain a liquid containing 800 ppm of calcium fluoride which fell out of a surface of the charged calcium carbonate. 5000 ppm of Resin Composite A was added to this water, and pressure filtration was performed by using a filter cloth having an aperture size of about 1 μm to eliminate calcium fluoride by employing the body feed method. It was confirmed that 99% or more of calcium fluoride in the water was eliminated. Subsequently, water was mixed with a layer deposited on the filter cloth to obtain a mixture liquid of the resin composite and the calcium fluoride, and the mixture liquid was transferred to another container to remove the resin composite by using a permanent magnet. It was confirmed that calcium fluoride was separated in the water. The removed resin composite was used again, and it was confirmed that the reuse was satisfactory.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A resin composite, comprising:
a plurality of aggregates of primary particles, each primary particle comprising a magnetic particle having a surface coated with a polymer,
wherein:
the primary particles have an average diameter between 0.5 μm and 20 μm,
the aggregates have an average aggregate diameter greater than the average diameter of the primary particles and less than or equal to 20 μm, and
the polymer has an average surface coating thickness between 0.01 μm and 0.25 μm.

2. The resin composite of claim 1, wherein each of the magnetic particles comprises magnetite.

3. The resin composite of claim 1, wherein the polymer comprises one or more polymers selected from the group consisting of polyacrylonitrile, polymethylmethacrylate, polystyrene, and copolymers thereof.

4. The resin composite of claim 1, wherein the polymer comprises phenolic resin.

5. The resin composite of claim 1, wherein the polymer comprises a condensate of trialkoxysilane.

6. The resin composite of claim 1, wherein:
the resin composite comprises a filter aid forming a precoat layer on a filter, and
wherein the filter aid is mixed with a dispersion medium to provide a suspension of the filter aid in the dispersion medium, and the suspension is filtered through the filter, thereby forming the precoat layer of the filter aid on the filter, and
wherein water to be treated containing a metallic ion is alkalified to precipitate metallic compound grains in the water to be treated, and
wherein the water to be treated containing the water-insoluble metallic compound grains is passed through the precoat layer and the filter, whereby the precoat layer captures the water-insoluble metallic compound grains, and
wherein a detaching water is directed to the precoat layer to detach the precoat layer from the filter, thereby providing a mixture of detached substance of the precoat layer which has captured the water-insoluble metallic compound grains and the detaching water, and
wherein the filter aid is magnetically separated from the mixture.

7. The filter aid for water treatment of claim 6, wherein the aggregate has a specific gravity which is larger than that of water.

8. The resin composite of claim 1, wherein the resin composite comprises a filter aid forming a deposit layer, together with water-insoluble metallic compound grains, on a filter, and
wherein water to be treated containing a metallic ion is alkalified to precipitate water-insoluble metallic compound grains in the water to be treated, and
wherein the filter aid is mixed with the water containing the water-insoluble metallic compound grains to provide a suspension of the filter aid and water-insoluble metallic compound grains in the water, and the suspension is filtered through the filter, thereby forming the deposit layer of the filter aid and the water-insoluble metallic compound grains on the filter, whereby the filter aid in the deposit layer captures the water-insoluble metallic compound grains contained in the water, and
wherein a detaching water is directed to the deposit layer to detach the deposit layer from the filter, thereby providing a mixture of detached substance of the deposit layer and the detaching water, and
wherein the filter aid is magnetically separated from the mixture.

9. The filter aid for water treatment of claim 7, wherein the aggregate has a specific gravity which is larger than that of water.

10. A precoat material for water treatment, comprising a filter aid,
wherein the precoat material is mixed with a dispersion medium to prepare a suspension of the precoat material in the dispersion medium,
the suspension is filtered through a filter, thereby forming the precoat layer of the precoat material on the filter,
water to be treated containing metallic ions is alkalified to precipitate water-insoluble metallic compound grains in the water to be treated,
the water to be treated is passed through the precoat layer and the filter, whereby the precoat material captures the water-insoluble metallic compound grains contained in the water to be treated,
a detaching water is directed to the precoat layer which has captured the water-insoluble metallic compound grains to detach the precoat layer from the filter, thereby providing a mixture of detached substance of the precoat layer and the detaching water, and
the filter aid is magnetically separated from the mixture,
wherein the filter aid comprises a plurality of aggregates of primary particles, each primary particle comprising a magnetic particle having a surface coated with a polymer, the primary particles have an average diameter between 0.5 μm and 20 μm, the aggregates have an average aggregate diameter greater than the average diameter of the primary particles and less than or equal to 20 μm, and the polymer has an average surface coating thickness between 0.01 μm and 0.25 μm.

11. The precoat material of claim 10, wherein the filter aid has a specific gravity which is larger than that of water.

12. A water treatment method, comprising:
alkalifying water to be treated containing a metallic ion, thereby precipitating water-insoluble metallic compound grains in the water to be treated;
mixing a filter aid with the water to be treated, thereby preparing a suspension of the filter aid and the water-insoluble metallic compound grains in the water to be treated,
filtering the suspension through a filter, thereby forming a deposit layer comprising the filter aid and the water-insoluble metallic compound grains on the filter;
directing a detaching water to the deposit layer, thereby detaching the deposit layer from the filter and providing a mixture of detached substance of the deposit layer and the detaching water;
magnetically separating the filter aid and the water-insoluble metallic compound grains, which are contained in the mixture; and
recovering the detaching water containing the separated water-insoluble metallic compound grains, and reusing the separated filter aid in subsequent mixing,
wherein the filter aid comprises a plurality of aggregates of primary particles, each primary particle comprising a magnetic particle having a surface coated with a polymer, the primary particles have an average diameter between 0.5 μm and 20 μm, the aggregates have an average aggregate diameter greater than the average diameter of the primary particles and less than or equal to 20 μm, and the polymer has an average surface coating thickness between 0.01 μm and 0.25 μm.

13. A water treatment method, comprising:
alkalifying water to be treated containing a metallic ion, thereby precipitating water-insoluble metallic compound grains in the water to be treated;
mixing a filter aid with a dispersion medium, thereby preparing a suspension of the filter aid in the dispersion medium;
filtering the suspension through the filter, thereby forming a precoat layer of the filter aid;
passing the water to be treated containing the water-insoluble metallic compound grains through the precoat layer and the filter, causing the precoat layer to capture the water-insoluble metallic compound grains contained in the water to be treated;
directing a detaching water to the precoat layer, thereby detaching the precoat layer from the filter and providing a mixture of detached substance of the precoat layer which has captured the water-insoluble metallic compound grains and the detaching water;
magnetically separating the filter aid and the water-insoluble metallic compound grains, which are contained in the mixture; and
recovering the detaching water containing the separated water-insoluble metallic compound grains, and reusing the separated filter aid in subsequent mixing,
wherein the filter aid comprises a plurality of aggregates of primary particles, each primary particle comprising a magnetic particle having a surface coated with a polymer, the primary particles have an average diameter between 0.5 μm and 20 μm, the aggregates have an average aggregate diameter greater than the average diameter of the primary particles and less than or equal to 20 μm, and the polymer has an average surface coating thickness between 0.01 μm and 0.25 μm.
